(19) United States
(12) Patent Application Publication
(10) Pub. No.: US 2004/0088894 A1
(43) Pub. Date: May 13, 2004

(54) Visual display utilizing toroids

(76) Inventors: Gary Haughton, Oakville (CA); Martin Behr, Ontario (CA); Tom Ostrowski, Ontario (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/467,660

(22) PCT Filed: Feb. 8, 2002
(86) PCT No.: PCT/CA02/00150

(30) Foreign Application Priority Data
Feb. 9, 2001 (US) 6026782

(51) Int. Cl. G09F 19/00

(52) U.S. Cl. 40/406

(57) ABSTRACT

A visual display apparatus for producing toroid rings of a first liquid within a second liquid is disclosed. The apparatus comprises a subtantially transparent viewing vessel for containing the second liquid. A variable volume chamber has an ejection orifice in fluid communication with the second liquid contained within the viewing vessel. An ejection means is also provided for varying the volume of the variable volume chamber, thereby to dispel an ejection slug of the first liquid from the ejection port, thereby producing a series of toroid rings which propagate through the viewing vessel. A control means is connected to the ejection means for controlling the operation of the ejection means. The operation of the control means may be such that it can be used to vary the volume and frequency of the ejection slugs emitted from the ejection orifice.

### FIELD OF THE INVENTION

The present invention relates to the field of mechanical devices that produce aesthetically pleasing visual effects for the relaxation and entertainment of viewers. More particularly, it relates to a visual display apparatus for producing toroidal-shaped rings known as “toroid rings” or “vortex rings”, of fluid which propagate through a larger volume of fluid, so as to create said aesthetically pleasing visual effects.

### BACKGROUND OF THE INVENTION

Various visual display devices are known which utilize liquids and gasses flowing and otherwise interacting in various manners to relax and entertain individuals who are within sufficient proximity to see and hear these devices. Most persons are familiar with so-called “lava-lamps”, which became popular in the 1960's. More recently, another well-known class of such devices popular for use indoors utilizes water running over stones, pebbles or other media so as to make a gentle gurgling sound mimicking a babbling brook. In some cases, these devices are sufficiently small so as to be mountable on top of a desk or a small table. Another class of these devices, which take many forms, utilize air bubbles released into a volume of water or the like in a clear or translucent vessel adjacent the bottom thereof, which air bubbles make their way to the top of the vessel. Various mechanisms are used in these devices to introduce varied patterns to the air bubbles, or to make them follow different pathways through the water, or to interact with other objects or devices within the volume of the vessel so as to make the visual display produced by said bubbles more interesting to the viewer. In all cases, however, the air, being less dense than the water or other liquid into which it is injected, rises to the surface of the vessel containing the liquid and dissipates to atmosphere, or is otherwise collected and recycled.

A more recent class of visual display device utilizes gas passing through a volume of liquid, such as water, in the form of one or more toroid rings, to form a visual display. The toroid rings of these types of devices are, as with other “bubble devices” discussed above, introduced into the viewing vessel from adjacent the bottom thereof, so that the rings travel, due to the lower density of the air, as compared to the water in the display cylinder or vessel, from the bottom of the viewing vessel to the top of the viewing vessel. Examples of this class of devices can be seen, for example in U.S. Pat. No. 4,534,914, issued Aug. 13, 1985 and in U.S. Pat. No. 5,947,784, issued Sep. 7, 1999.

U.S. Pat. No. 4,534,914 discloses an apparatus for producing toroid rings of a gas in a liquid comprising an accumulator which includes a gas inlet for introducing the gas under pressure from a gas supply source into the accumulator, and a gas outlet for discharging the gas. A nozzle is attached to the outlet of the accumulator in fluid communicating relation to the accumulator. The nozzle is of sufficient elasticity that the nozzle is sealingly closed when the liquid pressure exceeds the gas pressure in the accumulator. A valve means is provided in connected relation to the accumulator for permitting a gas supply from the gas supply source to reach the nozzle and for forming a gas stream at a higher velocity at the centre of the nozzle than at the inner periphery of the nozzle so that the toroid rings of gas can be formed. A means for actuating the valve means is also provided, said means being actuated when the gas pressure within the accumulator reaches a predetermined pressure level.

U.S. Pat. No. 5,947,764 discloses a device that produces vortex ring bubbles of gaseous fluid when immersed in a body of liquid of greater density than the gas. In a first embodiment, the device is operated by a person who blows into the device. In a second embodiment, the source of the gaseous fluid is any pneumatically charged device. In both, a normally closed valve, such as a poppet valve, is positioned on a second end of the device spaced from a first end at which the gaseous fluid is introduced. The valve opens and closes very rapidly in response to bursts of the gaseous liquid. Gas escaping around the peripheral border of the valve creates a toroidal bubble (toroid ring) that expands in volume as it approaches the surface of the volume of liquid.

While these latter two prior art visual display devices form toroid rings, they are limited by the physics inherent in the formation and uni-directional propagation (ie. bottom to top) of such rings through the use of a gas, such as air, injected into a liquid, such as water, or into some other liquid more dense than the gas forming the toroid rings. As such, they are, as with the passive “bubble display” devices mentioned above, significantly limited in the manner and type of visual displays they are able to efficiently produce. This inherent limitation is not only due to the aforementioned requirement of bottom to top toroid ring propagation, but also in large measure to the effect of gravity on the toroid rings formed from the gas, and to the limitations on the amount of energy that can be transferred by such prior art devices into toroid rings of gas travelling through a denser liquid. In any event, the display devices of the prior art are limited to generating and propagating toroid rings from adjacent the bottom surface within the viewing vessel towards the top of the viewing vessel, with little or no interference from cross-currents, or the like. In contrast, the visual display device of the present invention is not so restricted, such that the toroid rings generated by the display device may propagate upwardly from adjacent the bottom of the viewing vessel, from any one of the side surface(s)thereof, or indeed, from adjacent the top of the viewing vessel. Thus, toroid rings generated in the viewing vessel of the present invention can be propagated normal to the plane of the ejection orifice of the variable volume chamber in any direction, irrespective of gravity. Moreover, the liquid medium into which the toroid rings are launched can be contained within any type of free form or geometric shaped viewing vessel. Also, the device of the instant invention facilitates the imparting of sufficient kinetic energy to the toroid rings formed therein that they are able to travel along their projected axis through cross-currents, or other non-lineal interference, without substantial disintegration or break-up of the toroid rings.

Thus, a display apparatus according to the present invention allows for a wide array of complex interactions of toroid rings that are not taught, suggested or made possible by the prior art. For example, a visual display device constructed according to the present invention can provide visual displays incorporating the interaction of a plurality of toroid rings. Such interactions may include: a secondary vortex system in the wake of a primary toroid ring; reconnection of lines of vorticity; interactions between the toroid rings and the walls of the viewing vessel; toroid ring interactions with adjacent regions of strong vorticity. Even more complex and visually interesting interactions involving leapfrogging of toroid ring pairs is also possible with the device of the present invention. This interaction consists of two coaxial circular torroid rings, where one is projected though the other along their common projected axis. All of these features are easily manipulated in the subject display device through controlled variance of the volume and frequency of the slugs of liquid (hereinafter, an “ejection slug”) ejected through the ejection orifice, which ejection slugs form a toroid ring upon such ejection. Such controlled variance is possible through the use of a control means which may comprise anything ranging from a simple on/off switch to a pre-programmed digital computer or other CPU means.

During interaction of multiple toroid rings, the voricity where the rings collide (with one another, or with the walls of the viewing vessel) is deformed, with the cross-section of the rings becoming grossly distorted from their original form. The ensuing complex interactions ultimately result in deformation of the toroid rings. As such interactions proceed, zones of low velocity are established as part of the recirculation patterns within the volume of the viewing vessel. Such established recirculation patterns may serve as a mode of transport for any media (such as an immiscible liquid or beads of a coloured particulate matter) previously introduced into the viewing vessel and encapsulated within the toroid rings, where such immiscible liquid or beads are less dense than the liquid in the viewing vessel. This self-sustaining process is able to serve as a passive return system for such media in a continuous display device according to the invention, thus providing for a visually interesting, but relatively simple and inexpensive visual display device to manufacture. Alternatively, an active recirculation system for such beads or lighter density immiscible first fluid may be employed, which system may employ a pump means.

It is possible according to the present invention to generate well-defined toroid rings capable of travelling axial distances in excess of 100D, where “D” (see FIG. 2) is the outer ring diameter. Such action is dependent on the “formation number” of the toroid ring. A prior art discussion of these factors can be found in an article by Baird, M. H. I, Wairegi, T., and Loo, H. J. entitled “Velocity and Momentum of Vortex Rings in Relation to Formation Parameters”, published in the Canadian Journal of Chemical Engineering, 55:20, (1977), and in an article by Rohatgi, A., Baird, M. H. I, and Wairegi, T., entitled “Mixing Effects and Hydrodynamics of Vortex Rings”, published in the Canadian Journal of Chemical Engineering, 57:379, (1979). These articles teach that the critical formation number for a well-defined toroid ring is on the order of 2.0. The formation number is derived from the Le/d ratio, where “Le” is the effective ejection slug length, and “d” (see FIG. 1) is the diameter of the operative orifice through which the slug is ejected. Therefore, the total voume of fluid displaced should not be in excess of 0.5 πd³. These observations have been made at orifice Reynolds Numbers in the order of 3×10⁴ to 3×10⁵. Formation numbers above, or below, the above-mentioned range of values yield toroid rings of lesser-imparted kinetic energy and momentum. Such low energy rings may undergo viscous disintegration well before any interaction with other toroid rings, or with the walls of the viewing vessel of the subject invention.

### SUMMARY OF THE INVENTION

In accordance with the present invention there is disclosed a visual display apparatus for producing toroid rings of a first liquid within a second liquid. The apparatus comprises a substantially transparent viewing vessel for containing the second liquid. A variable volume chamber having an ejection orifice in fluid communication with the first liquid contained within the viewing vessel. An ejection means is mounted on the apparatus for rapid variance of the volume of the variable volume of the variable volume chamber so as to dispel ejection slugs of the first liquid drawn from the viewing vessel into the variable chamber thereby to produce a series of toroid rings which propagate through the viewing vessel. A primary control means is operatively connected to the ejection means for controlling the operation of the ejection means.

According to another aspect of the invention, the ejection means comprises a piston member slidably mounted for reciprocation within the variable volume chamber. According to another aspect of the invention, the piston member is driven by a pneumatic drive cylinder.

According to a further aspect of the invention, the primary control means may comprise a central processing unit (“CPU”) means. The CPU means may be operatively connected to the ejection means to randomly vary the volume and frequency of the ejection slugs serially emitted from the ejection orifice, in a random matter, or in any one of a number of pre-programmed and user selectable patterns.

According to yet another aspect of the invention, the display apparatus may be driven by a rotatable drive cam driven by an electric motor means, which electric motor means is operatively connected to the primary control means.

In accordance with a still further aspect of the invention, beads of a coloured particulate material of lesser density than the first liquid are entrained with in the ejection slug for propagation with said toroid rings, following the dissipation of which the beads float through the second liquid to the surface thereof. A means for recirculating said beads from adjacent the surface of the second liquid to the interior of the variable volume chamber is mounted on the apparatus in fluid communication with both the viewing vessel and the variable volume chamber to facilitate such recirculation of the beads.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

FIG. 1 of the drawings is a vertical section of a first embodiment of a visual display device according to the invention, with the first and second liquids removed from the viewing chamber for clarity of view of the-entire apparatus;

FIG. 2 of the drawings is a partial elevational view of a top portion of the device of FIG. 1, shown in a first operative configuration, with the first and second fluids operatively contained within the apparatus;

FIG. 3 of the drawings is a view, similar to FIG. 2, with the device shown in a second operative configuration;

FIG. 4 of the drawings is a view similar to FIG. 1, with the first and second fluids operatively contained within the apparatus and with a series of toroid rings travelling downwardly through the viewing vessel;

FIG. 5 of the drawings is a view, similar to FIG. 4, showing the destruction of one of said downwardly travelling toroid rings against a bottom wall of the viewing vessel;

FIG. 6 is a perspective view of the first embodiment of the apparatus as shown in FIGS. 2 to 5;

FIG. 7 is a view, similar to FIG. 2, of a second embodiment of a visual display device according to the invention;

FIG. 8 is a view, similar to FIG. 3, of said second embodiment; and

FIG. 9 is a view, similar to FIG. 2, of a third embodiment of a visual display device according to the invention.

### DETAILED DESCRIPTION OF THE PRESENTLY PREFERRED EMBODIMENTS

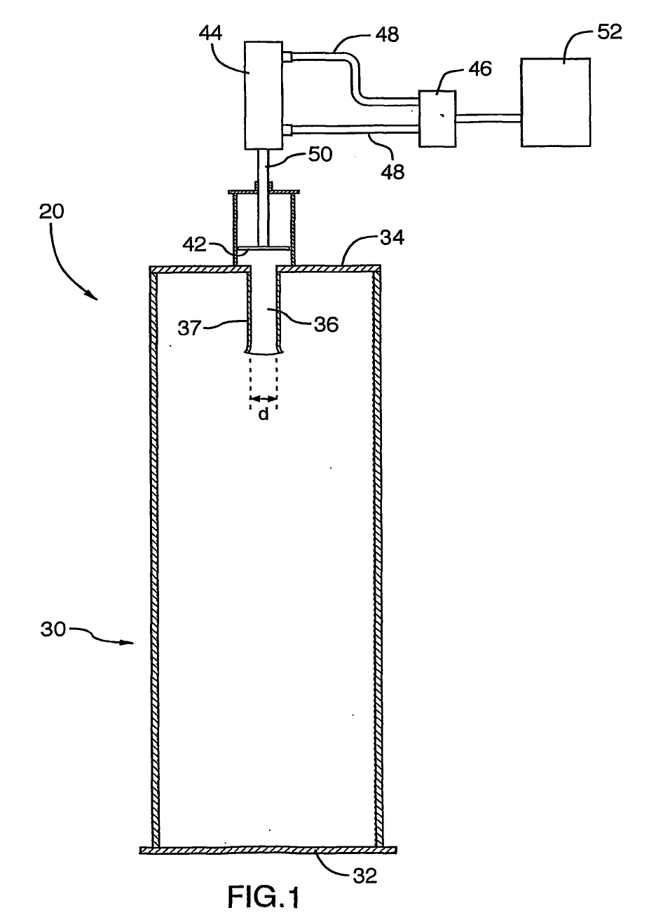

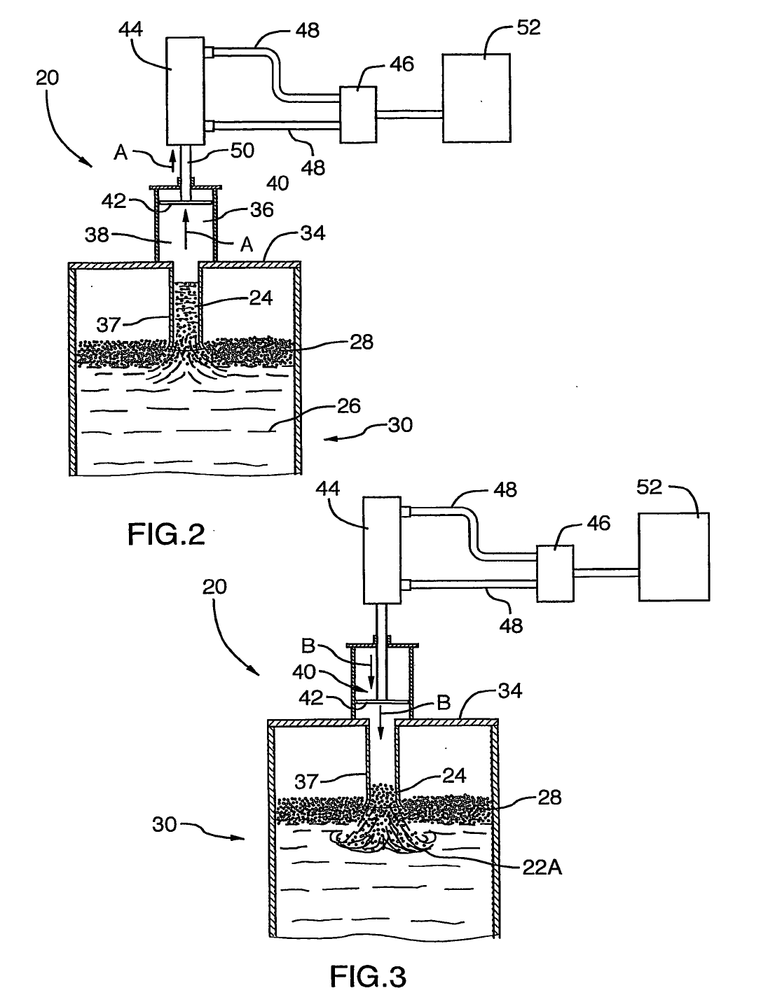

Referring now to FIGS. 1 through 6 of the drawings, a first embodiment of a visual display apparatus according to the present invention will now be described in detail. Such embodiment of visual display apparatus is designated by the general reference numeral 20. The apparatus produces toroid rings 22 from a first liquid 24 for propagation through a second liquid 24 for the relaxation and visual enjoyment of viewers. The first and second liquids may be of the same or different densities, and may be clear or coloured. In all of the embodiments illustrated herein, the first and second liquids are preferably both water; however, beads 28 of a coloured particulate matter of lesser density than water are, in all of the embodiments shown, preferably used to make the toroid rings 24 more visible to the viewer as they propagate through the device. Such beads 28 may be formed of, for example, a closed-cell foam, such as polyurethane or polystyrene. Other suitable materials may be selected by routine experimentation. Moreover, coloured beads 28 (as shown in the drawings) need not be used to enhance the visibility of the first liquid; rather, the first liquid may optionally be a coloured liquid of lesser density than the second liquid 26, provided that said first liquid 24 is immiscible in the second liquid 26 over a sustained period of time, so as to not dissolve therewithin. The apparatus further comprises a substantially transparent viewing vessel 30 designated by the general reference numeral 30, which viewing vessel takes the form of a glass, or plexiglass, rectangular cube standing on end in all of the embodiments illustrated herein. No particular shape of glass viewing vessel is mandated by the present invention. Any operative shape will suffice. The viewing vessel 30 has a bottom wall 32 and a top wall 34, neither of which need be transparent. The top wall 34 is preferably removable for maintenance purposes, and has mounted thereon a variable volume chamber 36 which is preferably of circular cross-section. The variable volume chamber 36 has positioned at its lower end an ejection orifice 38, which ejection orifice 38 is in fluid communication with the first liquid 24 contained within the viewing vessel 30, as will be seen from FIGS. 2 through 6.

An ejection means (indicted by the general reference numeral 40) is provided for rapidly varying the effective volume of the variable volume chamber 36 to form the toroid rings 24. In the first embodiment illustrated in FIGS. 1 through 6, the ejection means 40 comprises a piston member 42 slidably mounted for reciprocation within the variable volume chamber 36 to rapidly vary the volume of said chamber. The piston member 42 is, in the first embodiment, driven by a conventional pneumatic drive cylinder 44, which pneumatic drive cylinder 44 is conventionally connected by pneumatic control lines 48, 48 to a conventional pneumatic controller 46. A piston rod 50 drivingly connects the pneumatic drive cylinder 44 to piston member 42.

A control means 52 is also provided, which control means is connected to the ejection means 40 for controlling the operation of said ejection means. Such a control means may be as simple as an on/off switch for activating the pneumatic controller 46, or may be as complicated as a digital computer incorporating a CPU programmed to produce varied output signals to the pneumatic controller 46, which signals may correspond to a random or patterned sequence of movements of the piston member 42, which, in turn, would produce a sequence of toroid rings 22 to be ejected from the ejection orifice 38 in either a random or patterned sequence, as previously discussed.

As discussed more fully above, the outside diameter “D” of the toroid rings 22 is one of two key parameters in determining the energy characteristics and resultant sustainability of the toroid rings 22 ejected from the ejection orifice 38. This parameter is directly determined by the inside diameter “d” of the ejection orifice 38 (see FIG. 1). It is possible to dynamically control the diameter of the ejection orifice 38 by, for example, modifying the simple static ejection orifice 38 shown in FIGS. 1 to 6 to incorporate a variable diameter orifice, such as by use of an iris diaphragm (not shown) positioned to form the ejection orifice, which variable diameter orifice may then be placed under the control of a secondary control means (not shown), which secondary control means may itself be under the supervisory control of a primary control means 52.

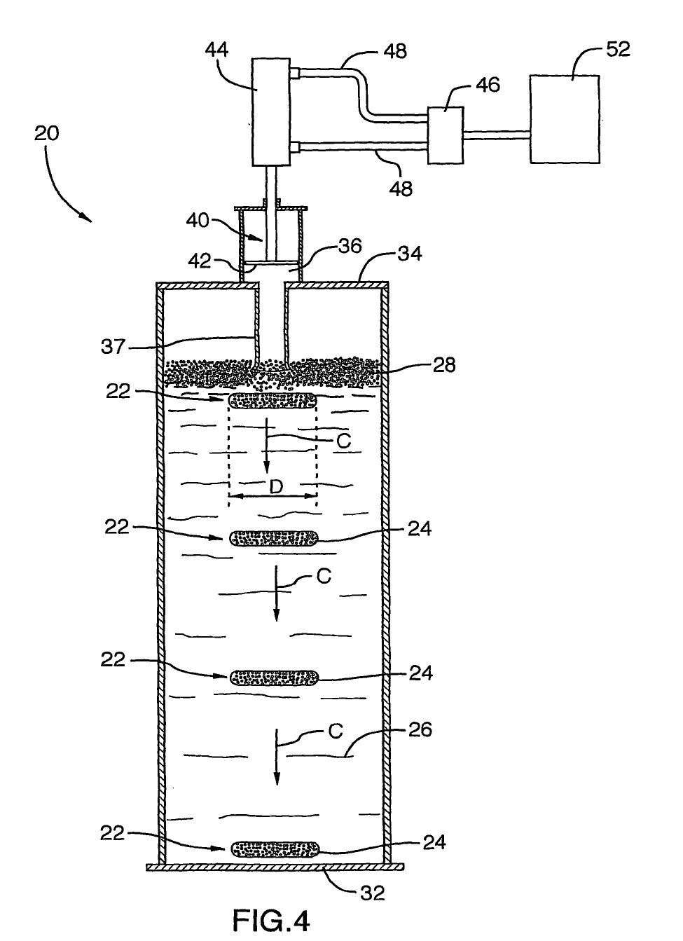

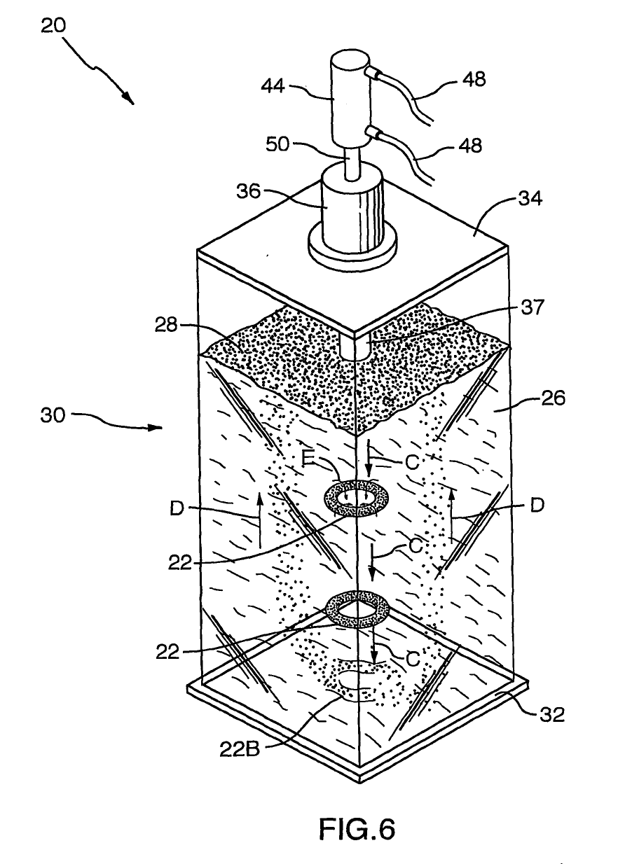

In use, the viewing vessel 30 of the visual display apparatus 20 of FIG. 1 is filled with a second fluid 26, such as water, to a level above the level of the ejection orifice 38, so that a discharge barrel portion 37 of the variable volume chamber 36 which contains the ejection orifice 38 is immersed in the second fluid 26. The beads 28, or other coloured material, are then added to the viewing vessel 30, and, due to their lighter density, they initially float so as to define a discrete first layer of fluid 24 (containing the beads 28) on top of the second liquid 26 within the viewing vessel 30. Sufficient beads 28 are added so that the orifice 38 comes into fluid communication with the first liquid. The beads can be of a wide variety of sizes ranging from barely visible to about 0.5 inches in diameter. The primary control means 52 is thereafter activated by a user, which, in turn, activates the pneumatic controller 46 so as to cause the pneumatic drive cylinder 44 to drive the piston rod 50 and the attached piston member 52 in an upward direction, as indicated by arrows “A” in FIG. 2, which in turn causes an increase in the volume of the variable volume chamber 36. This increase in volume causes a concurrent decrease in pressure within the variable volume chamber 36, which pressure decrease draws an ejection slug portion of the first liquid (which contains the coloured beads 28)into the discharge barrel portion 37. Once the piston member 42. reaches the top of its stroke, it has obtained a first operative configuration, as illustrated in FIG. 2. At this point, the piston member reverses direction by reversal of the flow of pneumatic fluid in each of the pneumatic control lines 48,48, under direction of the pneumatic controller 46, which causes the piston member 42 to travel downwardly in the direction of arrows “B” of FIG. 3, until the piston member 42 reaches the bottom of its stroke, which is shown as the second operative condition of the apparatus in FIG. 3. This downstroke of the piston member 42 causes the volume of the variable volume chamber to significantly and rapidly decrease, which causes the fluid forming the ejection slug to be forced through the ejection orifice 38 of the discharge barrel portion 37, thereby forming a toroid ring 22. Such a nascent toroid ring 22A can be seen forming immediately below the ejection orifice 38 in FIG. 3, and a serial plurality of fully formed toroid rings 22 can be seen moving through the viewing vessel 30 along a common axis in the general direction of arrows “C” in FIGS. 4, 5 and 6. Arrows “E” in FIG. 6 indicate the inwardly rolling motion of the toroid rings 22 as they propagate downwardly through the viewing chamber 30. It will be appreciated that each cycle (comprising an up and a down stroke of the piston member 52) will, in the manner just described, generate a single toroid ring. While not specifically illustrated in the drawings, a plurality of variable volume chambers gnerally analgous to that shown in FIGS. 1 through 6 and each having an ejection means 40 such as the recirprocating piston member 42 may be provided, with each of such chambers having an ejection orifice 38 in analagous fluid communication with the first fluid fraction. Moreover, the axis of propagation of the toroid rings produced by each of the plurality of variable volume chambers need not be parallel to one another; rather they can be transverse to one another, opposed to one another, or askew to one another. All of these options make possible a wide variety of different visual effects, all of which are within the scope of the present invention and are not taught nor suggested by the prior art. Also, the viewing vessel 30 may be divided by one or more fine membranes or the like (not shown) into a plurality of elongate separate chambers, with a respective number of variable volume chambers axially positioned one each over each such chamber. In this manner, beads of different colours can be utilized in each respective chamber so produced, thereby providing for toroid rings of different colours to traverse down each respective chamber, and to recirculate therein as described more fully below.

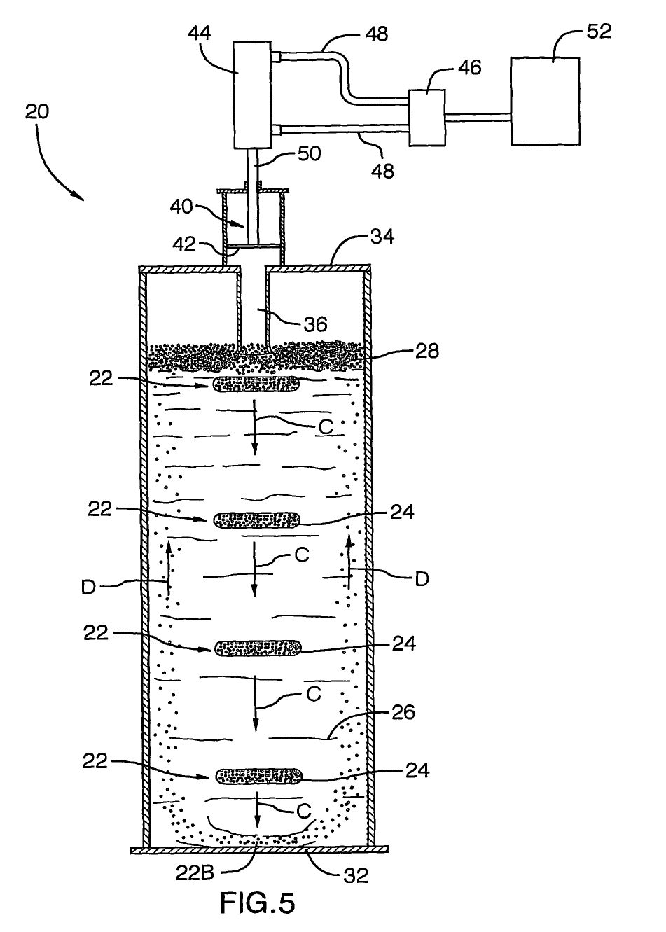

As seen in FIGS. 5 and 6, when a particular toroid ring 22B impacts the bottom wall 32 of the viewing vessel 30, it will disintegrate and the coloured beads 28 entrained within the first fluid 24 forming such ring 22B will, due to their lighter density and loss of forward momentum, drift passively outwardly towards the peripheral side walls of the viewing vessel 30, and thence generally upwardly through the second liquid 26, as indicated by arrows “D” of FIGS. 5 and 6. Eventually such beads 28 will return to the zone from which they originated, that is, adjacent to and floating upon the surface of the second liquid 26, from which zone they can again be drawn into the discharge barrel portion 37 of the variable volume chamber 36 for recycled entrainment within a newly generated toroid ring 22. Thus, a passive system for recycling of the coloured beads 28 within the viewing vessel 30 of the subject apparatus 20 is disclosed.

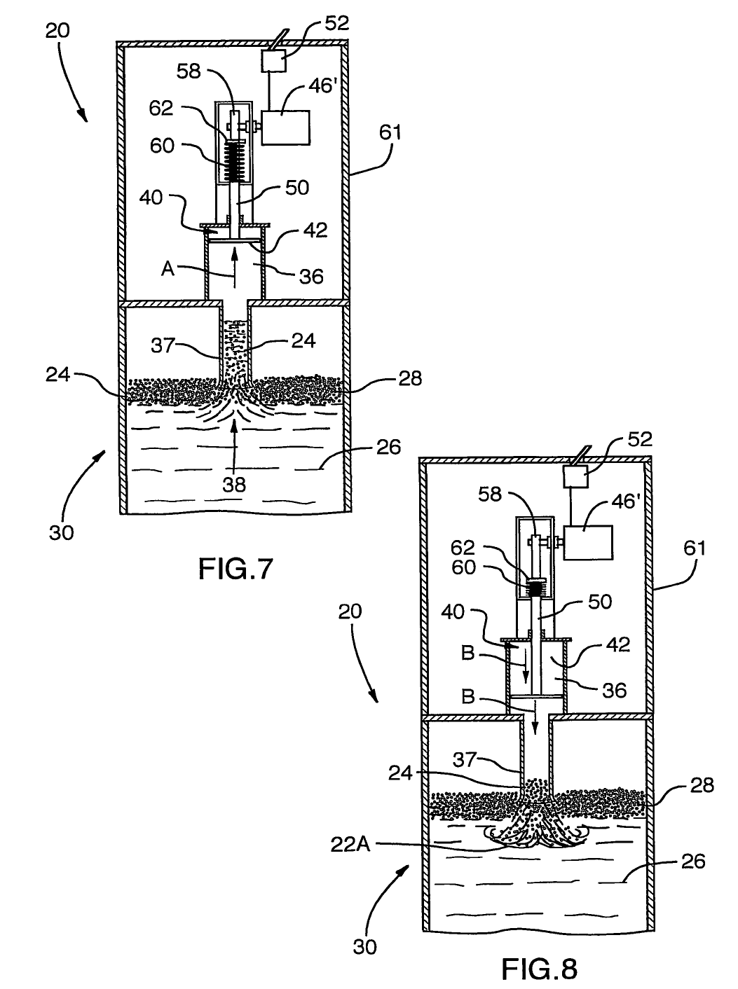

Turning now to FIGS. 7 and 8, there will be seen a second embodiment of visual display apparatus according to the invention, which embodiment is similar in most significant respects to the first embodiment of the invention illustrated in FIGS. 1 through 6, such that like reference numerals will be used to refer to analogous structures in all views. The second embodiment differs from the first embodiment in that the pneumatic drive cylinder 44 is replaced by a mechanical drive system as follows. More particularly, the piston member 42 is driven by a rotatable drive cam 58, which drive cam is rotated by an electric motor means 46′, which electric motor means 46′ is operatively connected to a primary control means 52, which can be as simple as an on/off switch (as shown in FIGS. 7 and 8), or which can be as complicated as a conventional CPU means integrated into a digital computer, programmed to send a patterned set of control signals to the electric motor means 46′ and/or a random series of such control signals thereby to generate a corresponding patterned, or random, series of pulses of the piston member 42, which in turn will generate a resultant series of toroid rings 22 to be emitted from the ejection orifice 38, as described more fully herein.

A return spring 60 encircles the piston rod 50, as shown in FIGS. 7 and 8, and engages the underside of a terminal flange 62 extending radially outwardly from the upper end of the piston rod 50, so as to assist in the upward movement (ie. return stroke) of the piston member 42. It will thus be apparent that energization of the motor means 46 causes rotation of the eccentrically lobed drive cam 58, which causes a downward reciprocation of the piston member 42, which will be followed by an upward movement of the piston member 42 under the upward biassing of the return spring 60 as the lobe 58′ of the drive cam 58 passes bottom dead centre. It will be apparent that upward travel of the piston member 42 in the direction of arrow “A” of FIG. 7 causes an increase in the volume of the variable volume chamber 36 in the same general manner as illustrated with the first embodiment in FIG. 2, while downward travel of the piston member 42 in the direction of arrows “B” of FIG. 8 causes a decrease in the volume of variable volume chamber 36 in the same general manner as illustrated with the first embodiment in FIG. 3. This latter movement causes the expulsion of the ejection plug through the ejection orifice 38 of the second embodiment in the same manner as with the first embodiment, thereby generating a nascent toroid ring 22A, as seen in FIG. 8.

An optional cover member 61, constructed of opaque plastic material or the like, may be removably positioned over the top end wall 34 of the viewing vessel 30 so as to conceal the exposed portions of the variable volume chamber 36, the ejection means 40, the primary control means 52 and the electric motor means 46′, with the primary control means 52 (ie. an on/off switch) being mounted in operatively protruding relation on the cover member 61.

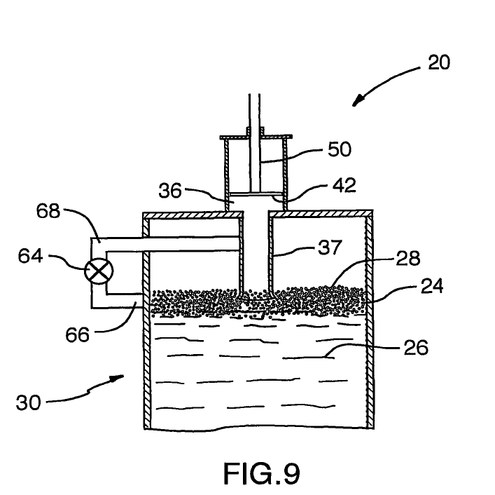

In FIG. 9, a third embodiment of a visual display apparatus according to the invention is shown. In this embodiment, the piston member 42 may be driven in any operative manner, including the two modalities shown in the first and second embodiments. For this reason, the remainder of the apparatus above the level of the piston rod is, for the ease of illustration, not shown. Also for this reason, like reference numerals are used in connection with the third embodiment to designate structures which are analogous to those shown in the first two embodiments. Rather, the third embodiment differs from the first two in additionally providing an active means for recirculating the first liquid and any coloured beads 28 contained within said first liquid. In this embodiment, a means for recirculating the beads 28 from the surface of the second liquid 26 is provided in the form a small recirculating pump 64. The recirculating pump 64 is mounted on the apparatus 20 in fluid communication with both the viewing vessel 30 and the variable volume chamber 36 to facilitate active recirculation of the beads from the surface of the second liquid into the variable volume chamber for incorporation into the ejection slug for ejection from the ejection orifice 38 as a component of the toroid rings 22 formed by the apparatus 20. As discussed more fully elsewhere herein, said beads 28 have, on account of their lower density, already made their way through the second liquid 26 to the surface thereof, wherein they are collected by a suction pipe 66 in fluid communication with the pump means 64 for discharge by the pump 64 via supply pipe 68 into the barrel of the variable volume chamber 36, as shown in FIG. 9. In this manner, a constant supply of such beads 28 is made readily available in the variable volume chamber 36 for discharge as part of the toroid rings 22.

Various other modifications and alterations may be used in the design and manufacture of a visual display apparatus according to the present invention without departing from the spirit and scope of the invention, which is limited only by the accompanying claims. For example, toroid rings laden with magnetic media (in place of or in addition to said coloured beads) can have their trajectory affected when passing through a magnetic field generated within a portion of the viewing vessel, to further vary the display in visually interesting manners. Moreover, the magnetic field can be varied along the projected axis of propagation of the toroid rings, with such variation also being under the control of the primary control means 52. Also, beads of heavier density material than the second liquid 26 may also be used in place of the lighter density beads 28 illustrated in the Figures. In such case the toroid rings containing such heavier density beads can be ejected with significant kinetic energy from the bottom of the viewing chamber towards the top surface of the second liquid. Once they reach the second surface, they will fall backwards to the bottom surface of the viewing chamber, wherein they can be recirculated by one of the recirculation modalities discussed above. An easier way of visualizing this is to turn any one of the three embodiments illustrated in FIGS. 1 through 9 through 180 degrees of rotation, and thereafter load beads of heavier density than the second fluid into the viewing vessel.

Another variation not illustrated in the drawings is to insert a barrier plate (not shown) into the viewing vessel in transverse relation to the axis of propagation of the toroid rings and at the level of the top surface of the first liquid, with a central aperture in the plate to accommodate the throughpassage of the discharge barrel position 37 of the variable volume chamber 36. The purpose of such a barrier chamber plate is to provide a barrier at the surface of the first liquid to stop the beads/particles from floating on the surface, where they might possibly allow small amounts of air to be drawn into the variable volume chamber 36 along with the beads/particles. This is especially valuable to use in conjunction with the active recirculation system shown in the third embodiment of FIG. 9.

We claim:

1. A visual display apparatus for producing toroid rings of a first liquid within a second liquid comprising:
a substantially transparent viewing vessel for containing said first and second liquids;
a variable volume chamber having an ejection orifice in fluid communication with said first liquid contained within the viewing vessel;
an ejection means mounted on the apparatus for rapid variance of the volume of said variable volume chamber so as to dispel from the ejection orifice ejection slugs of the first liquid drawn from the viewing vessel into the variable volume chamber so as to produce a respective series of said toroid rings which propagate through the second liquid; and
a primary control means operatively connected to said ejection means for controlling the operation of said ejection means.

2. A visual display apparatus according to claim 2, wherein said ejection means comprises a piston member slidably mounted for reciprocation within the variable volume chamber.

3. A visual display apparatus according to claim 2, wherein said piston member is driven by a pneumatic drive cylinder.

4. A visual display apparatus according to claim 3, wherein said primary control means comprises a CPU means.

5. A visual display apparatus according to claim 2, wherein said piston member is driven by a rotatable drive cam.

6. A visual display apparatus according to claim 5, wherein said rotatable drive cam is rotated by an electric motor means, which electric motor means is operatively connected to said control means.

7. A visual display apparatus according to claim 6, wherein said control means comprises a CPU means.

8. A visual display apparatus according to claim 1, wherein beads of a coloured particulate material of lesser density than said first liquid are entrained within said ejection slugs for propagation with said toroid rings, following the dissipation of which said beads float through said second liquid to the surface thereof, and wherein a means for recirculating said beads from adjacent the surface of said second liquid to the interior of the variable volume chamber is mounted on the apparatus in fluid communication with both said viewing vessel and said variable volume chamber to facilitate said recirculation.

9. A visual display apparatus according to claim 1, wherein the ejection orifice is of a diameter which is variable by means of a secondary control means.

10. A visual display apparatus according to claim 9, wherein said control means and said secondary control means are each integrated into a CPU means.

11. A visual display according to claim 1, wherein said liquid is coloured and of a lesser density than said second liquid.

12. A visual display apparatus according to claim 11, wherein said first liquid is entrained within said ejection slugs for propagation with said toroid rings, following the dissipation of which said first liquid floats through the second liquid to the surface thereof, and wherein a means for recirculating said first liquid from adjacent the surface of said second liquid to the interior of the variable volume chamber is mounted on the apparatus in fluid communication with said viewing vessel and with said variable volume chamber to facilitate said recirculation.
